(19) United States
(12) Patent Application Publication
(10) Pub. No.: US 2021/0310227 A1
(43) Pub. Date: Oct. 7, 2021

(54) TOILET DEVICE WITH SUPPORT FUNCTIONS

(71) Applicant: Karl-Josef KRAMER, Livermore, CA (US)

(72) Inventors: Werner Kramer, Bad Breisig (DE); Karl-Josef Kramer, Livermore, CA (US)

(21) Appl. No.: 17/264,273

(22) PCT Filed: Jul. 31, 2019
(86) PCT No.: PCT/US19/44506

§ 371 Date: Jan. 28, 2021

Related U.S. Application Data
(60) Provisional application No. 62/713,276, filed on Aug. 1, 2018.

(51) Int. Cl. E03D 9/08; H04N 5/232; G06T 7/00; H04N 5/225; G03B 17/56; G02B 27/00

(52) U.S. Cl. CPC E03D 9/08; H04N 5/23299; H04N 5/23203; G06T 7/0014; H04N 5/76; G03B 17/561; G02B 27/0006; G06T 2207/30088; H04N 5/2256

(57) ABSTRACT

A toilet device with inspection functions, with highly controllable cleaning, drying and reporting functions is presented. Said device is geared towards users with impaired mobility and sensory functions, such as overweight people, people lacking strength or reach, as well as, and in particular, paraplegic and quadriplegic users with sensory impairments. This device allows the user to take full control of observing their bowel movement as well as controlling proper cleaning and drying afterwards, including optional post drying treatments such as using lotions in inflamed areas. Voice activation, push button, touch screen and joystick control allow for direct, flexible and reliable control of the implemented functions, despite a user's potential impairments. Logging and reporting to caretakers or doctors provides possibility for quick interaction and feedback, as well as tracking diet incompatibilities when coupled to or compared with a user's diet diary.

### CROSS-REFERENCE TO RELATED APPLICATIONS

This application claims priority to U.S. Provisional Application Ser. No. 62/713,276, filed Aug. 1, 2018, which is hereby incorporated by reference in its entirety.

### FIELD

The present technology relates to toilet devices with integrated functions for cleaning, drying, inspection or treatment.

### BACKGROUND

While the majority of humans uses toilet devices which are all conceptually very similar and are merely equipped with water flushing but no additional functionality, there are toilets on the market that include Bidet functions, i.e. a water-based cleaning rinse jet or shower spray using water which can be heated and drying functions for the user's posterior, anal or front genital region, as well as further functions such as automated toilet lid opening and closing functions which often are triggered by a sensor. Such functions are often tailored to people seeking additional hygiene or just a more luxurious or convenient treatment. Such functions could be called optional for many people.

However, there are large groups of users for whom such functions can mean significant improvement of their quality of life, but whom these devices are not tailored to, since additional functionality would be required to make a sufficient difference. These users are people who have limited mobility, either from having strength, weight or reach issues or from having handicaps, such as paraplegic or quadriplegic people. Injured or elderly people often fulfill one or more such criteria as well. Toilets with highly automated, yet affordable functions catering to said people are not yet readily available on the market. Visually impaired people also benefit from a high degree of automation, as well as, if residual vision is still available, from visual enhancement techniques through the features presented in this disclosure.

### SUMMARY

The device and technology presented in this disclosure seeks to overcome one or more of the limitations seen in toilet devices for mobility limited users. When using the toilet, people with limited mobility will benefit very strongly from the herein disclosed features which allow direct observation, automation, flexibility and remote control of toilet and cleaning functions. These functions are key topics of this invention.

People with limited mobility often cannot see and inspect their excretions or sense the completion of the excretion process. In addition, they are not able to sense their posteriors after excretion and cleaning.

No toilet user currently can actually see and visually inspect their posterior, anal or frontal genital region directly after excretion and post-excretion cleaning when using a standard toilet on the market today.

This disclosure teaches several embodiments where one or more observation cameras, fixed or mobile, are applied within a toilet device, with capability for viewing the excretion process, the excrement and a user's posterior, anal and frontal genital region, and with disclosed features which enable keeping said observation cameras protected and maintaining their cleanliness and operability.

It also teaches the use of either voice control, touch screen or other remote touch control, joy stick control or a combination thereof for applying bidet functions of rinsing and drying and for moving cameras to allow the user to view and inspect the entire region of interest and to control the cleaning function, and for keeping said cameras protected, clean and operable.

In addition, it teaches the use of image recognition for determining whether the user's posterior is sufficiently undressed while using the toilet.

Also, it teaches the use of image recognition for determining a variety of abnormalities common to a user's posterior, anal or front genital region, for instance skin abnormalities such as decubitus, abscesses, fissures, fistulas, hemorrhoids, cuts, open wounds, as well as yeast infections, or, for female users, can even detect the onset or presence of menstrual bleeding.

For paraplegic and quadriplegic users, our disclosure is also essential for directly observing completion of the excretion process, as well as for observing cleaning and drying, as such users often have little or no sensation in addition to their lack of mobility to observe these critical points. Being able to have full control over each such process or status is self-evident for many. Yet the observation and direct control rendered through using said cameras and control functions can make a significant contribution to self-confidence and overall quality of life to those with said restrictions or handicaps.

The features provided in this disclosure are also amenable and very useful to users without mobility impairment, for example, it can be used by people whose medical issues require visual inspection with documentation of their stool, their posterior, anal or front genital region.

### BRIEF DESCRIPTION OF THE DRAWINGS

The features, nature, and advantages of the disclosed subject matter may become more apparent from the detailed description set forth below when taken in conjunction with the drawings in which like reference numerals indicate like features and wherein:

FIG. 1a depicts a toilet device with a telescopic arm that contains bidet functions rinsing and drying as well as a camera, with illumination device, such as a light emitting diode (LED). The telescopic arm has two degrees of freedom for motion: a telescopic in-out function and a side-to-side swivel function.

FIG. 1b depicts the same toilet device with a view from above.

FIG. 1c is a side view of a toilet device and illustrates the use of distance sensors to control and optimize cleaning water spray.

FIG. 1d represents a tilted side view of a toilet device with a front partial closure mechanism.

FIG. 2 shows a side view of a toilet device with a telescopic arm that contains bidet functions rinsing and drying as well as a camera. The telescopic arm has two degrees of freedom in motion: a telescopic in-out function and a rotation function.

FIG. 3 shows a top view of a toilet device with two telescopic arms, where one telescopic arm contains bidet functions and the other telescopic arm contains a camera function.

FIG. 4 shows a close-up depiction of a telescopic arm with camera function of a toilet device and with cleaning and optional drying nozzles for regular cleaning of said telescopic arm with camera upon entering or exiting the sheath of the telescopic arm.

FIG. 5 shows a side view of a toilet device with telescopic arm and with a pair of cameras, where one camera observes the area below and the other camera the area above the telescopic arm.

FIG. 6a shows the top view of a toilet device with a plurality of cameras and illumination devices, such as LED's, wherein said cameras and illumination devices are integrated in the bowl, yet protected by a surface layer such as glass or plexiglass, which is integrated into the inner toilet device bowl in a sealed fashion, either through the use of glue or caulk, of a gasket or by directly thermally sealing in the window as the bowl is manufactured.

FIG. 6b shows the side view of the toilet device from FIG. 6a.

FIG. 7 depicts a user of an automated toilet device, with a touch screen monitor control that is movable towards the user and with a joy stick for controlling the camera itself or for camera-controlled operation observation and bidet functions and any other desired functions, such as powdering or oiling desired regions of the users exposed skin.

FIG. 8 depicts a conceptualization of a touch screen for control of a toilet device with automatic, semiautomatic or otherwise motorized or actuatable functions.

FIG. 9a depicts a top view of a toilet device with the additional controllable, potentially telescopically movable application system with dispense nozzle for a powder or an oil or lotion spray dispenser which can be used to treat the exposed surface of a user.

FIG. 9b depicts a tilted side view of a toilet device with the additional controllable, potentially telescopic function of acting as a powder or oil or lotion spray dispenser to treat the exposed surface of a user.

FIG. 10a depicts a bottom-up view as detectable by a camera implemented in one of several embodiments listed in this disclosure. Depicted are clothing tails along the inner rim of the seat that are not desirable during the toilet use. Image recognition software of the camera is to display and alert the user if needed, such that the user can remedy the situation.

FIG. 10b depicts a bottom-up view as detectable by a camera implemented in one of several embodiments listed in this disclosure. Depicted are, for one, regions that require cleaning, as well as skin regions of a user's buttocks where significant skin issues or abnormalities are observed, such as decubitus, hemorrhoids, fissures, abscesses or others. An image recognition system is employed to detect and classify such abnormalities.

FIG. 11a depicts a tilted side view of a toilet device with air extraction. Extraction ports in this embodiment are integrated into the toilet seat and collected in the rear of the toilet device. A pump or fan attracts extracted air from the toilet bowl and pushes it through a smell filter, such as a bubbler, or a charcoal filter, and then exhausts it, either into the room or through a port in the wall (not shown).

FIG. 11b depicts a top view of the same toilet device from FIG. 11a.

### DETAILED DESCRIPTION

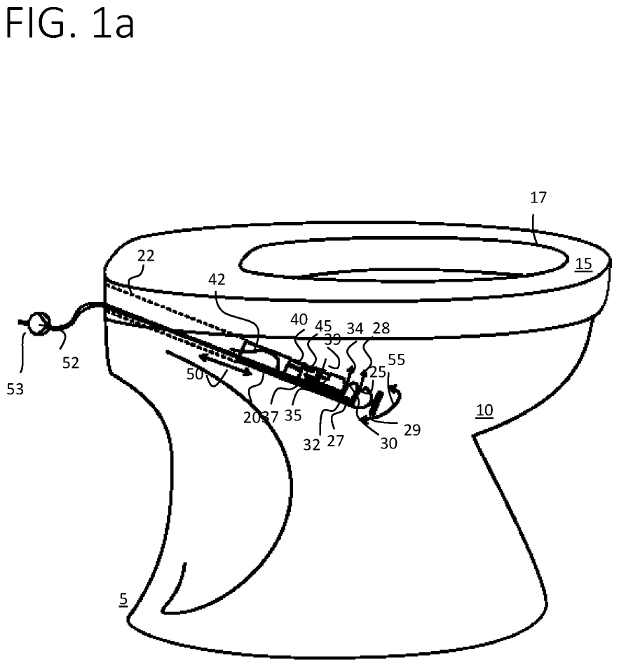

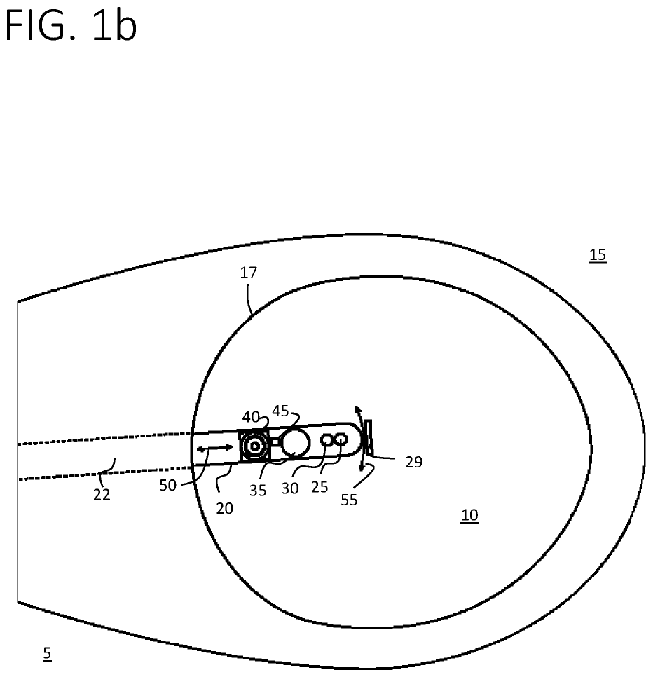

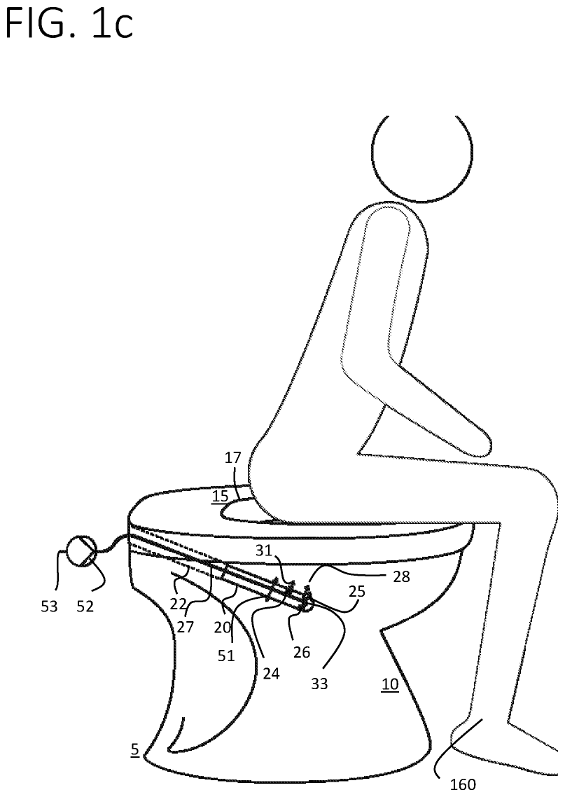

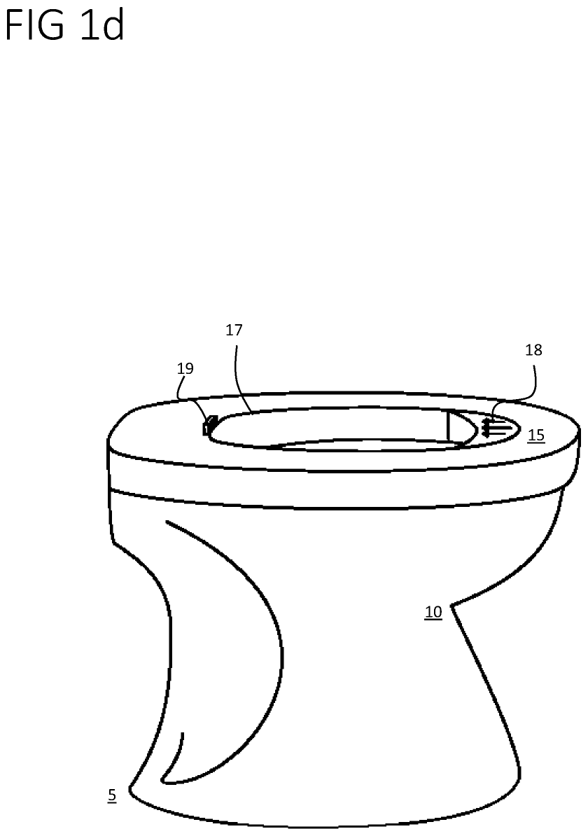

FIG. 1a depicts the tilted side view of a toilet device 5, with toilet bowl 10 with flushing capability, toilet seat 15 which houses specific innovative functions described as part of this disclosure, with toilet seat rim 17 and with a controllable, driven extendable and retractable telescopic arm 20, with a home position in a telescopic arm sheath 22 which contains bidet functions and observation functions described below, wherein said sheath and drive mechanism to said telescopic arm are housed and integrated in the rear part of said toilet seat 15. Said bidet functions consist of cleaning or rinsing with cleaning nozzle 25 providing a water jet or shower spray, fed by cleaning water line 27, drying with drying nozzle 30 fed by drying line 32, optional drying air extraction with extraction opening 35 and extraction line 37. Cleaning water spray 28, drying air flow 34 and exhaust air flow 39 are also indicated in the figure. An optional cleaning or rinsing water splash guard 29, potentially equipped with a rinse function is also indicated. Said observation functions can consist of at least one conveniently small camera 40, mounted to and integrated within said driven telescopic arm 20, with camera control cable 42 and with suitable illumination, if required, such as a light emitting diode (LED) 45. Said movable camera setup with an extended engaged position of said camera and illumination, as well as with a retracted position within a sheath allows the toilet user to view on-demand their posterior, anal and front genital region, as well as their excrement and urine. Said illumination may preferably be mounted on the telescopic arm 20 and in proximity and close to collinear to said camera, in order to prevent shading from objects being illuminated. Said telescopic arm 20 depicted in this figure has two degrees of freedom in motion: a telescopic in-out function 50, which is required and a side-to-side swivel function 55, which may be advantageous. Water to the cleaning water line is provided by a pump 52 with adjustable or controllable pressure or flow rate and via a water feed line 53.

It is to be noted that for the illumination 45 it is advantageous to have illumination with good color fidelity, such as available from a white LED with not only a blue emitter plus yellow phosphor content, but also with sufficient red components, since LED's from merely blue and yellow typically produce red deficient light.

Two dimensions of freedom for these active components provide a significant increase in usability of this device for motion impaired users, especially when used in conjunction with user-controlled actuation. This is especially the case for the cleaning part of the described functions, where a second degree of freedom for the motion enables better coverage of the user's region to be cleaned.

The motorized functions of the telescopic bidet arm can be used to address cleaning, observation and treatment of the user's posterior and anal region but also of the user's front genital regions.

FIG. 1b shows the same toilet device from a top view.

A common worry voiced by inexperienced users of integrated bidets is related to the strength and direction of the cleaning water spray. FIG. 1c, which is a tilted side view of a toilet device 5 with a user 160, discloses a means to accommodate and alleviate such worries. To do so, additional features are added: Firstly, an additional degree of freedom for the telescopic arm with the bidet functions may be added, preferably an up-down movement 51 of the arm. Using information from a proximity sensor 24 or 26 with sender and receiver function such as a red or infrared reflective sensor akin to such sensors used for autofocusing of cameras, may be used in conjunction with said third degree of motion for the telescopic arm. Such sensors have an outgoing beam and capture a reflecting light, often in essentially the same spot, highlighted by arrows 31 or 33. In particular, such an up-down motion 51, which places the arm in the correct distance to the surface to be cleaned, can be employed to adjust and optimize the strength of the rinse spray 28. In addition, or alternatively, such sensing can be fed back to a water pump 52 with water intake 53 which provides the cleaning water pressure, like a pulsating water pump such as those used for other pulsed cleaning applications, or to a programmable water valve if water house pressure is used, and water pressure or flow through said pump or valve and to the water spray nozzle or nozzles 25 through water line 27 can be adjusted. Specifically, proximity sensing can be used also as a turn-off criterion for the cleaning water spray, such as to avoid water spray from being dispensed whenever there is no target within a programmed range of proximity and thus avoid accidental over-spraying. In one situation, such an optical sensor can be mounted concentric to the rinsing water spray, as shown by sensor 26 and transmitting and reflected receiving light beams 33. The sensor receiver combination needs to be tuned properly and should not be too sensitive to erroneous refraction from water spray drops and the likes. A pulsating water spray may help take or analyze distance measurements specifically at times in a cycle when pump pressure is low or off. Sensor location may preferably be either close and parallel to the water spray, as shown by sensor 24 with transmitting and reflected receiving light beams 31 or even concentric to the water spray like sensor 26 with transmitting and reflected receiving light beam 33. However, measurement may be simplest with the sensor being located at a higher position away from the water spray arm. A calibration factor including analysis of the current height position of the telescopic arm can be used to correct for errors in distance measurement between water spray impact position and distance measurement position. Naturally, such spray strength can also be adjusted manually (either in addition to or instead of the sensor-controlled spray strength), e.g. by a cleaning water flow regulating knob or by an on-screen or voice activated command.

Another safety mechanism to prevent overspray is shown in FIG. 1d. A partial closing mechanism 18 of a toilet 5 with toilet bowl 10 and toilet seat 15 with inner rim 17 can be attached in such a way along the rim 17 that it enables gentle, potentially force-limited closure of the frontal region of the toilet seat rim 17, if a user presence sensor 19 detects a user and if the user enables said closure by voice, push-button joystick or touch-screen activation, as presented later within this disclosure. Said closure mechanism can be limited by distance sensing, force sensing, fixed positioning, user's stop command or a combination thereof.

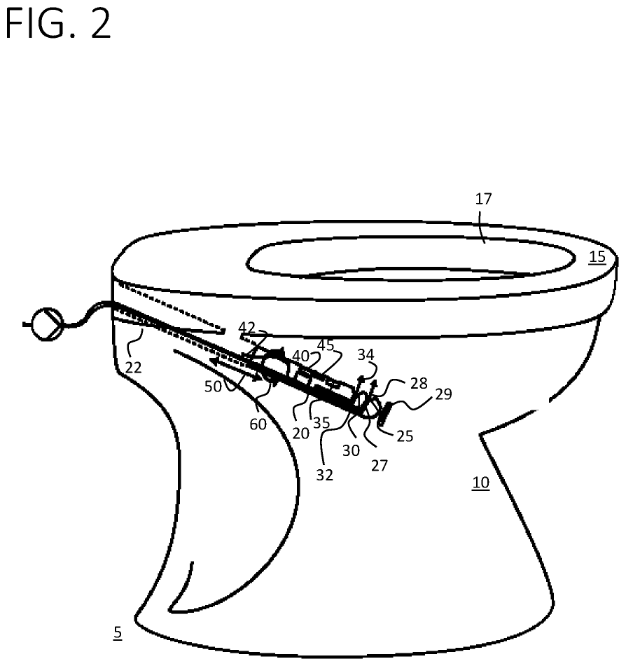

FIG. 2 shows a tilted side view of a toilet device 5 with a toilet bowl 10 with flushing capability and with a toilet seat 15 housing specific innovative functions, with a driven telescopic arm 20 that contains bidet functions rinsing and drying as well as a camera. Similar to the device in FIG. 1, the telescopic arm has two degrees of freedom in motion, yet in this embodiment, the telescopic arm 20 has a telescopic in-out function 50 and a rotation function 60 wherein the telescopic arm rotates essentially around its telescopic axis.

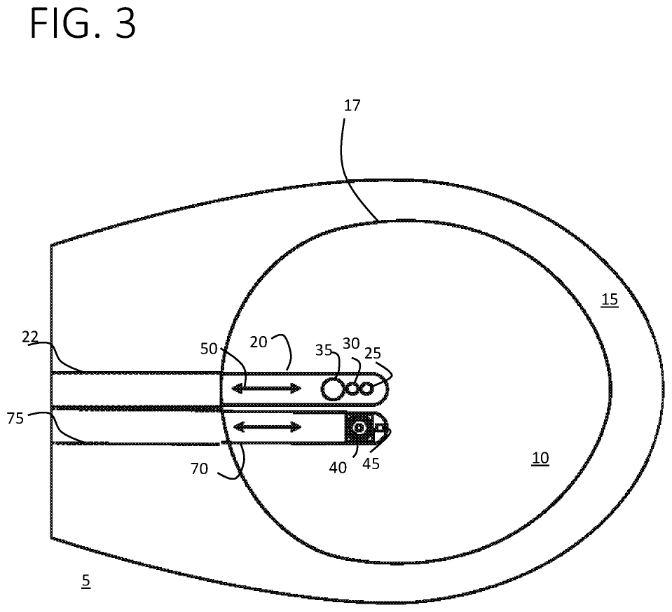

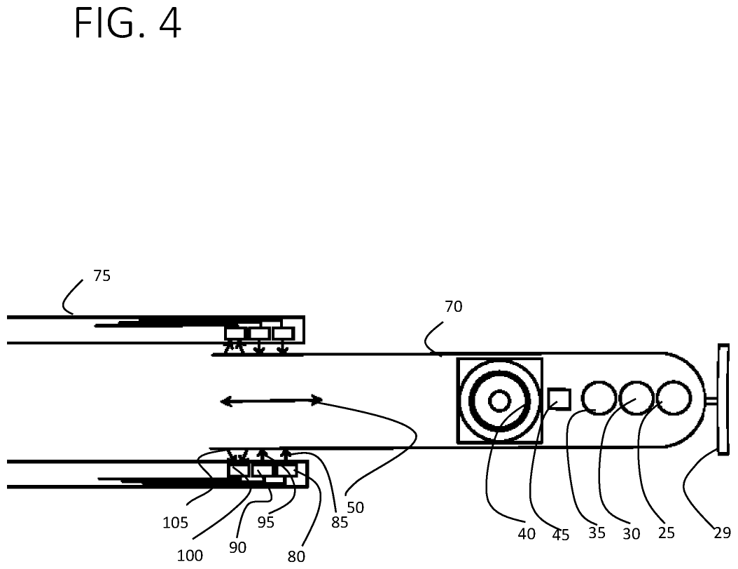

FIG. 3 shows a top view of a toilet device 5 with toilet bowl 10 and toilet seat 15, akin to FIGS. 1 and 2, but in this embodiment with two separate and independently driven telescopic arms 20 and 70, with their respective retraction sheaths 22 and 75, and wherein one telescopic arm 20 contains bidet functions 25, 30 and 35, while the other telescopic arm 70 contains camera function 40 with illumination 45. Such an arrangement allows the user to obtain a fixed image by holding said camera 40 steady while running a sweeping cleaning or drying process using the other respective driven telescopic arm. While FIG. 4 only depicts the inward and outward motions of the respective telescopic arms, it is readily conceived that the additional degrees of freedom of motion as presented in FIGS. 1 and 2 may be applied to each individual driven telescopic arm.

FIG. 4 shows a close-up depiction of a telescopic arm 70 with camera function 40 of a toilet device 5 (not shown, but depicted in earlier figures) and with cleaning and optional drying nozzles for regular cleaning of said telescopic arm with camera upon entering or exiting the sheath 75 of the telescopic arm in telescopic in-out motion 50. Water rinse line 80 supplies rinse nozzle 85, while drying line 90 supplies drying nozzle 95. Optional extraction line 100 supplies suction pressure to extract opening 105 to remove moisture and drying air from the location. Instead of one rinse nozzle 85, a plurality of rinse nozzles can also be designed, including also rinsing capability for the optional rinse water splash guard 29. As depicted here, it is advantageous to locate said nozzles close to the exit port of the sheath, such as to easily be able to clean the telescopic arm along its length. It can also be advantageous to locate a drying nozzle inside of the cleaning nozzle. Also, it is envisioned that cleaning liquid, typically water, and drying gas, typically air, can be applied sequentially through the same nozzle, in a sequential cleaning and telescopic arm motion sequence.

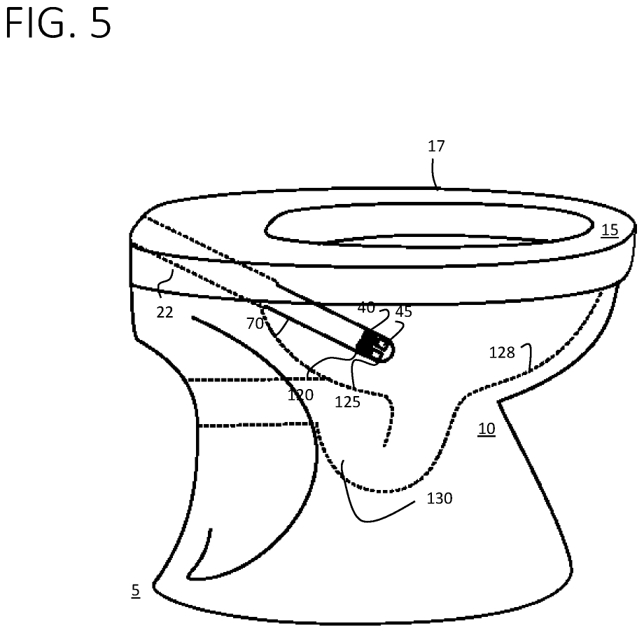

FIG. 5 shows a tilted side view of a toilet device 5 with toilet bowl 10 with flushing capability and flushing path 130, toilet bowl base 128 and toilet seat 15 akin to described in previous figures, with telescopic arm 70 and with a pair of cameras 40 and 120 with respective illuminations 45 and 125, where one camera 120 observes the area below and the other camera 40 the area above the telescopic arm 70. Also depicted is the water flushing path 130 in the toilet bowl. Such arrangement allows for the simultaneous and convenient imaging of a user's posterior, anal and front genital regions using camera 40 for top-viewing and imaging a user's excrement or urine using bottom-viewing camera 120.

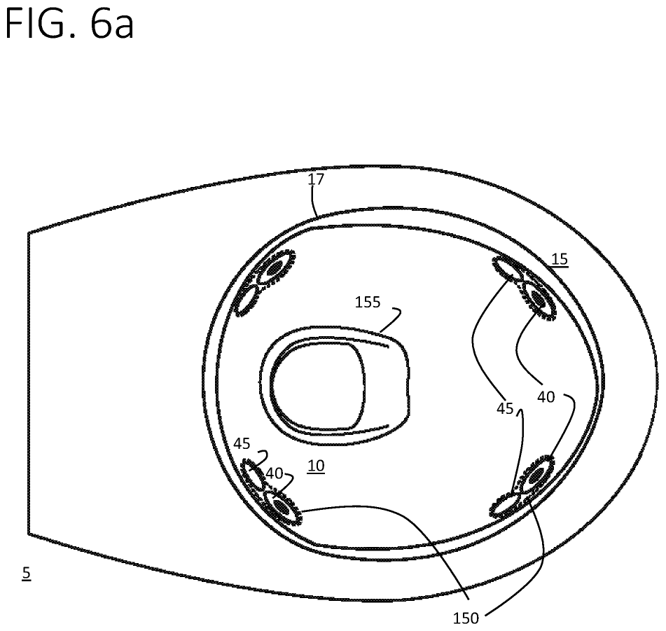

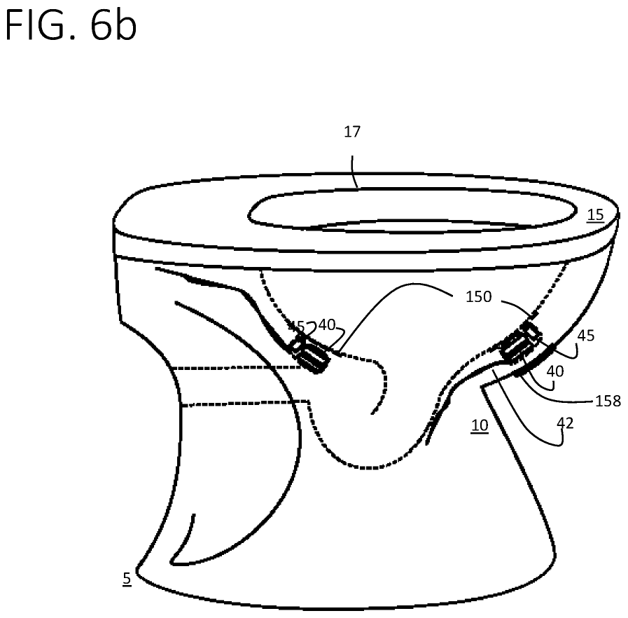

FIG. 6a shows the top view of a toilet device 5 with toilet bowl 10 and toilet seat 15, with one or more cameras 40 and illumination devices 45, such as LED's, wherein said cameras and illumination devices are integrated in the wall of toilet bowl 10, yet protected from liquid and from soiling by a transparent surface material 150 such as glass or plexiglass which is integrated into the inner toilet device bowl in a sealed fashion, said sealing accomplished either through the use of glue or caulk, of a gasket or by directly thermally sealing in the window as the bowl is manufactured. Proper sealing as well as imaging using said cameras is enabled by placing said cameras in a position substantially above the default or resting liquid level 155 of said toilet bowl 10. Such fixed installations of cameras can be used to observe cleaning and drying functions such as those disclosed in earlier figures herein or skin health monitoring functions as described below in this disclosure. Proper positioning of said cameras may allow imaging both the user's stool as well as the user's posterior, anal or front genital regions prior and after cleaning, drying or other treatment.

FIG. 6b shows the tilted side view of the toilet device 5 from FIG. 6a. Further illustrated are routing paths of camera cables 42. Also depicted is an access port 158 to said camera 40 and illumination 45 assembly, which allows for easy and accessible maintenance or exchange of said camera 40 or illumination 45.

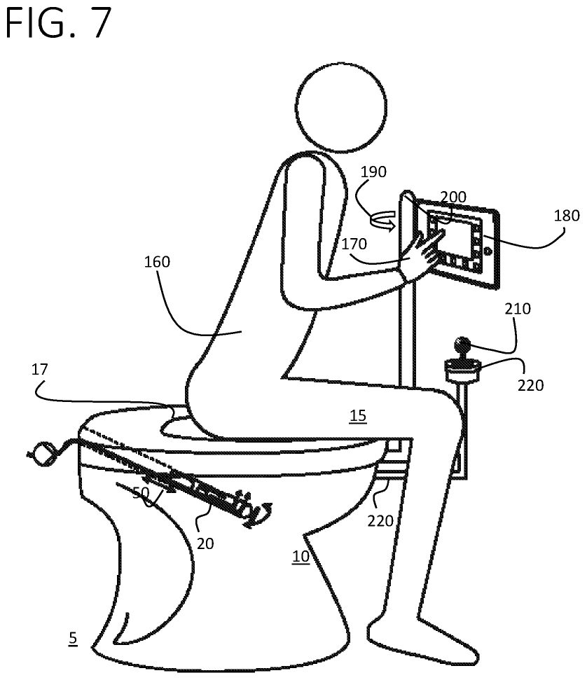

FIG. 7 depicts a user 160 of an automated toilet device 5, sitting on toilet seat 15 with rim 17 wherein said toilet seat houses innovative functions described within this disclosure. Said toilet device is connected to a control system with a touch screen viewing monitor 180 which serves as a controller and which is placed within easily reachable proximity of a toilet user so that a user can access it with their hand 170 and which is movable towards the user, or to a caregiver assisting the user using swivel arm 190 and rotation motion 200, and alternatively or in addition with a joy stick 210 for camera-controlled operation of observation, image taking and bidet functions and any other desired functions located and accessible on one or more telescopic arms 20, such as powdering or oiling desired regions of the users exposed skin. What is not shown is that the same commands to be applied via a touch screen monitor or joystick are also envisioned as voice activated controls, particularly for those users with impaired use of their upper extremities, such as quadriplegic users. It is also conceived that the same viewing and control monitor functions that are herein depicted as being part of an integrated monitor can be executed via an App installed on a smart phone or tablet. The overall control system hardware connecting camera and bidet functions such as cleaning and drying can reside partially integrated within the toilet seat, preferably in the rear section of the toilet seat, or be integrated with a viewing monitor. For the case of using a smart phone or tablet based App as user interface, the controller hardware may advantageously reside integrated with the toilet device and particularly within the toilet seat.

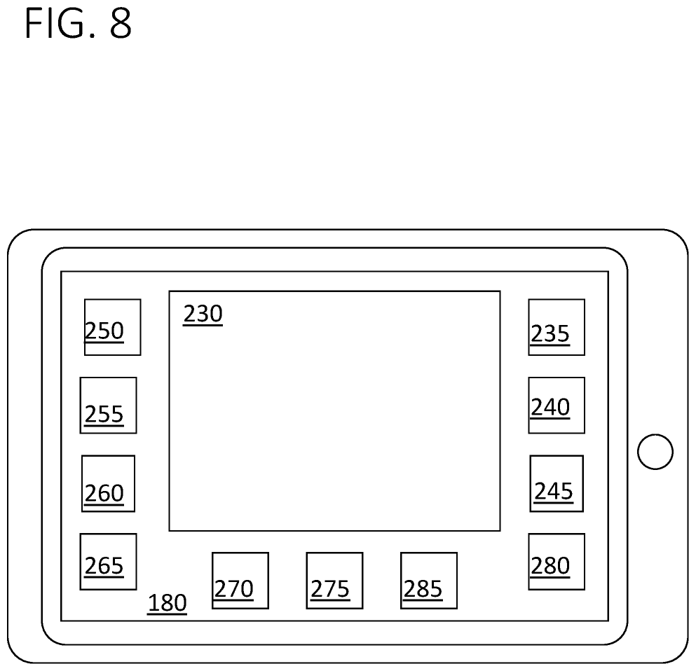

FIG. 8 depicts a conceptualization of a touch screen 180 as a user interface or control monitor for control of a toilet device with automatic, semiautomatic or otherwise motorized or actuatable functions. This is to be understood as an example for a menu of a graphical touch screen user interface. A myriad of suitable interfaces with similar functionalities are conceivable.

The user optionally logs in via login tab 280. Different users are recognized. Area 230 acts as the viewing monitor and displays any image, either a live image or a reopened historic image or an image just taken, either of a stool sample or of a user's posterior, anal or genital region, or of the excretion or cleaning process. Touching area 235 opens an image storage submenu. Area 240 connects to an image transfer submenu. Area 245 opens a submenu to open historic images or data from diary or log file. Area 250 activates a cleaning and drying submenu, area 255 commences the inspection functions. Area 260 controls the optional lotion, oil or powder application functions. Area 265 opens diary and logging functions. Area 270 deals with reporting functions, while area 275 provides access to various settings. Area 285 may activate flushing.

People with impaired mobility and especially those with impaired or missing sensation in their posteriors often suffer from inflamed pressure sore spots or regions (decubitus) on their posterior from not alternating their position often enough when sitting or lying or from sitting, lying or leaning on hard surfaces. Such symptoms can be detected readily and early by the user before causing long term problems. Said early detection is achieved through said camera observation functions presented in this disclosure. Said images can be stored and optionally be sent via email or similar messaging systems to a caregiver or medical professional. Additionally, said automated toilet device can be extended by the additional functionalities of locally applying soothing or healing lotions, oils or powders to affected areas. The same holds for any inflamed tissue around a user's posterior, anal or frontal genital region.

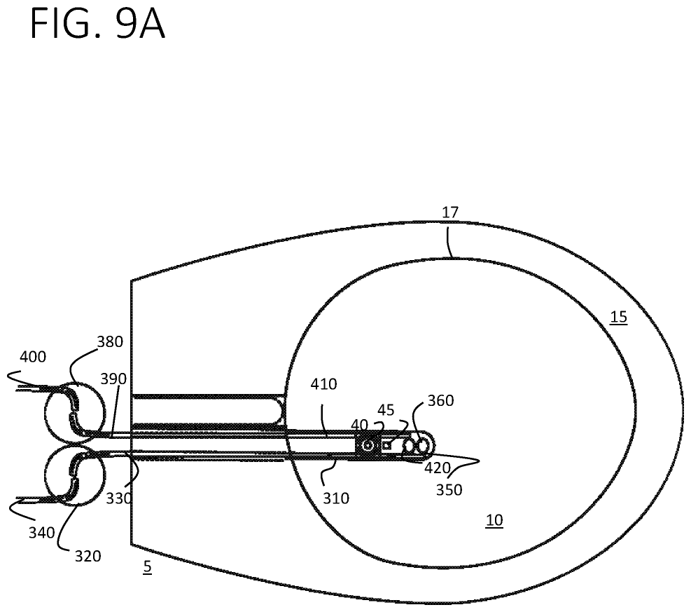

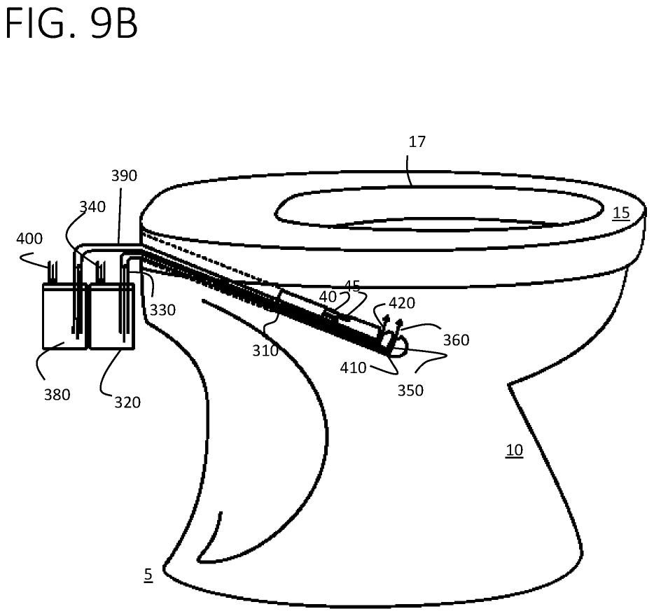

FIGS. 9a and 9b depict a toilet device 5 with toilet bowl 10 and toilet seat 15 and with the additional controllable, potentially telescopically actuatable functions of acting as a powder or oil or lotion spray dispenser to treat the exposed surface of a user. The disclosed features allow for application of oil, lotion or powder and for control of position, process and quality of said application. FIG. 9a illustrates the embodiment from a top-down view, whereas FIG. 9b depicts the same embodiment from a tilted side view. Integrated camera device 40 with illumination 45 are established in FIGS. 9a and 9b on same telescopic arm 310 that also carries the applicator nozzles 360 and 420 of oil or lotion and of powder, respectively; yet camera and illumination may also be placed on a separate telescopic arm or other separate location, such as depicted in FIGS. 6a and 6b. Said camera and illumination allow for observation and control of positioning and quality of dispense for said oil, lotion or powder. Especially by using an actuation mechanism with two degrees of freedom, similar to mechanisms depicted earlier in this disclosure, a user can choose to selectively apply said oil, lotion or powder to affected areas. For such an application, the toilet device in FIGS. 9a and 9b contains a telescopic arm 310 for the application of said materials. In the depicted embodiment a vessel 320 containing lotion or oil has a dispense line 330 connected into a dispense line 350 in the telescopic arm, leading to dispense nozzle 360. A burst of air through line 340 which pressurizes or temporarily pressurizes said dispense line can be used to cause a dispense burst. Depending on the oil or lotion's viscosity, a misting apparatus can be implemented as well, akin to standard mist dispense heads applied to household cleaning bottles and the like.

A similar device is employed to dispense a medical powder, with a vessel 380 containing the powder, a powder dispense line 390 leading into a powder line 410 in the telescopic arm and to a powder dispense nozzle 420 at the point of use. A pressurization line 400 can be controlled to provide dispense bursts and can be operated automatically or distinctly by the user.

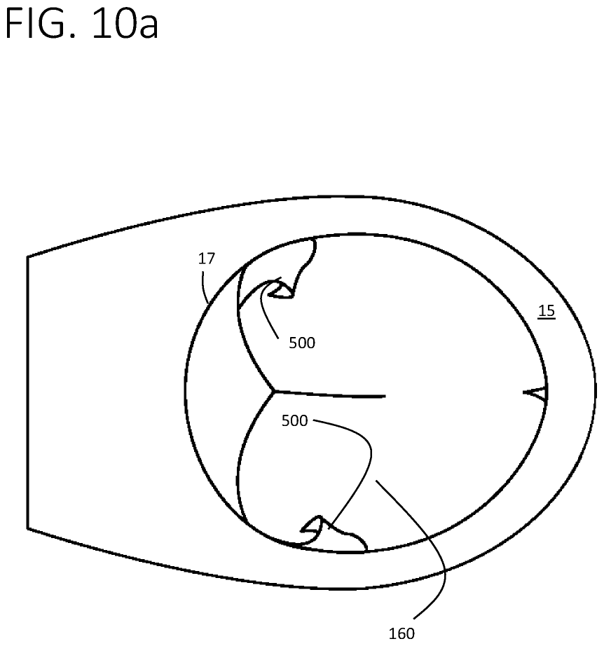

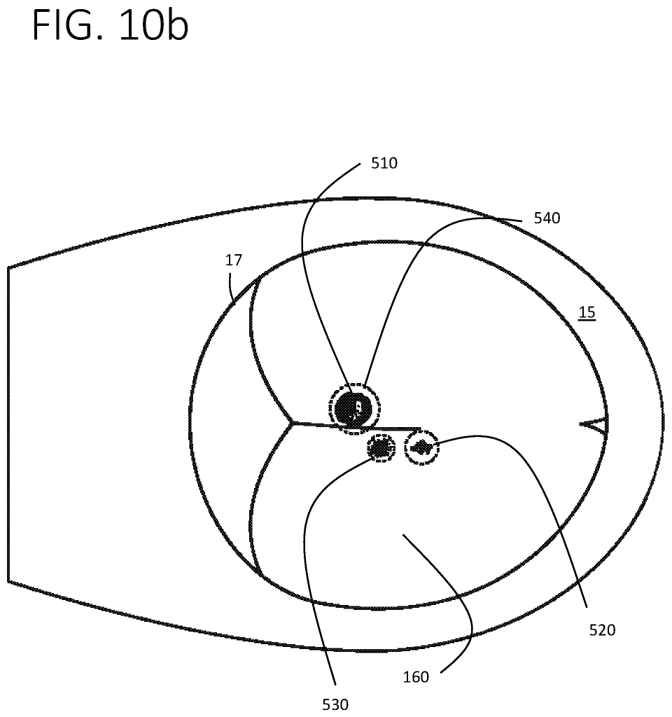

Mobility and sensory impaired users may have difficulties in assuring that their posterior, anal or front genital region is sufficiently undressed prior to using the toilet device. FIG. 10a depicts a user 160 sitting on toilet seat 15 with rim 17, with a view from below, enabled by one of the camera and illumination devices 40 and 45, as taught in other figures herein. It is depicted how such a bottom-up camera view can be implemented to detect shirt tails 500 or other interfering clothing along the inner rim 17 of the seat 15 that are not desirable during the toilet use. Image viewing by the user, but also image recognition software of the camera is to display and alert the user if needed, such that the user can remedy the situation.

FIG. 10b depicts a similar view from below of a user 160, sitting on a toilet seat 15 with rim 17, illustrating what may be captured by a camera placed on an extendable and retractable telescopic arm within a toilet device with toilet seat housing certain functions, as described elsewhere in this disclosure. FIG. 10b depicts examples for abnormalities that may be viewed and captured by said camera, including a region 510 of residual contamination requiring post-excretion cleaning, a region 520 depicting a skin abnormality such as an abscess, a region 530 depicting a skin abnormality such as a decubitus sore region. Image recognition software can be executed for analyzing images captured in this way, and when image processing returns regions of interest, it can highlight them to a user by placing feature locator rings 540, optionally annotated or with different, identifying colors around said regions of interest. Images taken by users on toilets as described in this disclosure can be collected and stored, respecting user's privacy, can be evaluated and fed into a data base from which, via use of image recognition and artificial intelligence, certain abnormalities can be located and a suggested identification and classification can be executed, thus providing direct feedback to the user, which in turn can be interpreted and followed up further by a user and/or their care giver or medical contact point.

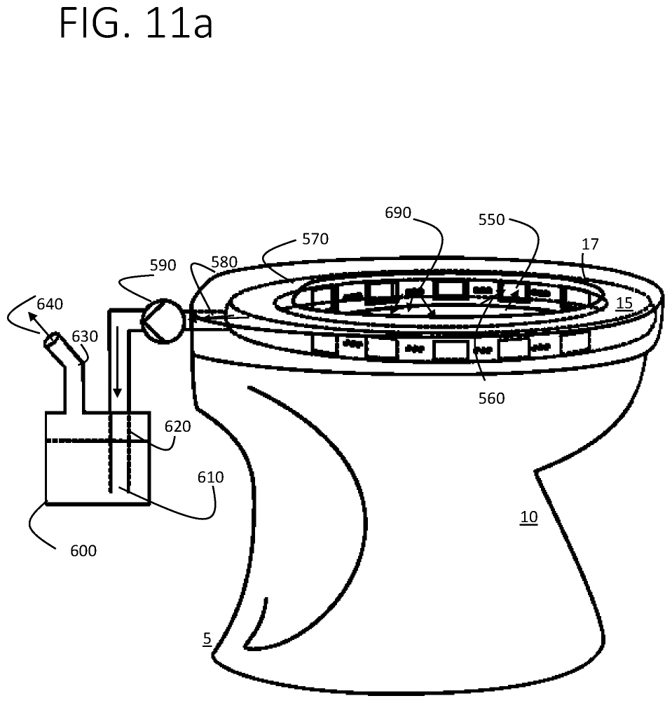

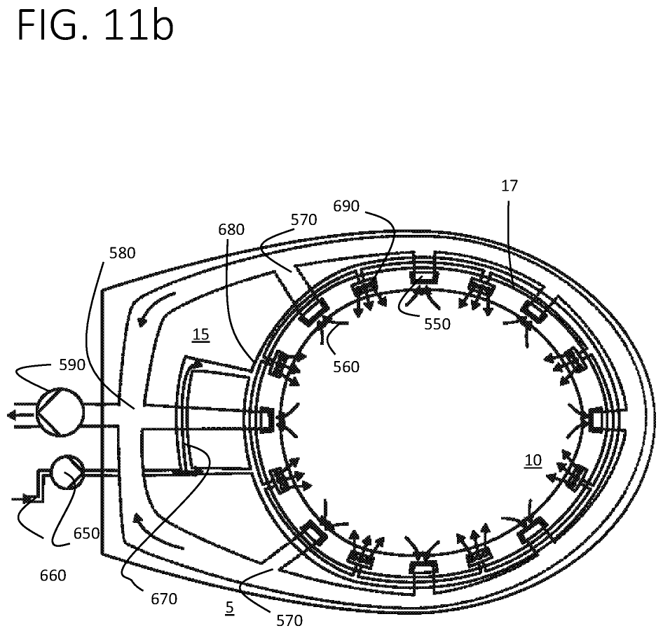

With additional rinsing and drying functions, as well as for general hygiene and reduction of olfactory impact, it can be advantageous to add active air extraction to a toilet device. FIG. 11a depicts a tilted side view of a toilet device 5 with toilet bowl 10, toilet seat 15 and rim 17 with active air extraction. FIG. 11b depicts a top view of the same device. Extraction ports 550 in this embodiment actively remove the air 560 and are integrated into the toilet seat along the rim 17. Through air ducts 570 in the seat, the air from the circumference of the rim is collected in the rear at collector 580 of the toilet device and guided to a pump or fan 590. Said pump attracts extracted air from the toilet bowl and pushes it through a filter 600, which can contain water 610 with potentially a scent included. Duct 620 guides the extracted air into the water such as through a scrubber or bubbler and then exhausts it via path 630 to port 640, either into the room or through a port in the wall to an outside area (not shown). Alternatively, the filter can consist of a simple active carbon layer instead of water. An additional feature of said toilet seat can be the introduction of drying air channels, optionally heated. For that, an air blower 650 with optional heating function pulls in ambient air through an inlet 660 and distributes it through an air distributor 670 into the sides of the toilet seat where it is guided through air channels 680 to drying air nozzles or outlets 690. This construction, with air extract, air distribution or both can also serve to provide a controlled air flow which reduces or prevents the risk of splashing of cleaning water from the water spray nozzle into areas outside the bowl.

While devices and functions in this disclosure are preferably equipped with cleaning mechanisms, which can ideally be put into an automatic routine, such as a rinse and dry with every use, it is still advantageous to design each of the devices in this disclosure such that they can be removed easily for periodic cleaning, maintenance or replacement. Especially a design allowing complete removal of all motorized features from an otherwise mainly stationary toilet bowl can be advantageous.

It is to be noted that while all descriptions in this disclosure allude to a user applying the available functions of said toilet device by themselves, its advantages are equally applicable if a caregiver supports the user with the use of the device.

While the actuation functions presented here mainly consist of telescopic in-out motion plus swivel (yaw) or rotational (Pitch) axis motion, it is apparent that other actuation mechanisms, including cartesian motion (X, Y) and others are equally employable and are covered within this disclosure.

The camera observation function integrated into the toilet device allows for a variety of beneficial functions. Firstly, images can be taken, stored, analyzed and forwarded to caregivers or doctors. Said images can consist of stool sample images. However, the camera images also cover users' posterior, anal or front genital regions and provide valuable help in tracking digestive system health as well as anatomic health. Any skin abnormalities can be detected at an early stage and relayed to the user and their caregiver or medical contact.

The cameras used herein should be equipped with autofocusing capability or at least provide high focus depth and focus at close range, with wide angle lenses and best with digital correction of wide-angle errors. As the cameras are moved throughout the device, a proper image stitching software can be advantageous. The controlling software should contain a diary function where the users can either store information by themselves or cause an automatic storage of information, as to stool consistency, weight, color, as well as any pain associated with bowel movement. Images should be time stamped for later comparisons. Inspection can be carried out on all the users' exposed parts. Such information, when coded correctly, can be coordinated with other diary functions the user may have which track the users' diet. By doing so, allergic or otherwise negative reactions (reddening, diarrhea, constipation, pains and others) can be traced back to diet intake with better certainty.

The camera can optionally have an image recognition function to detect for instance residual clothes within the rim of the toilet seat.

For cleaning and drying, the camera can be used to verify both a properly cleaned posterior surface and anal or front genital region, as well as, optionally, a properly dried surface, if changes in reflectivity can be suitably analyzed. The cleaning and drying process can be done in an automatic fashion with recurring fixed sequence of rinsing and drying. But it can also leave the user to inspect afterwards and do a touch-screen or joystick controlled dedicated clean or rinse using a camera as live control unit after initial cleans. This is of significance for people with impaired mobility or sensation, as there may be user types without any sensory feedback during the cleaning and drying steps.

From a mechanical point of view, it is advisable that the toilet seat be equipped with a sensor for presence of a user, as well as with an optional mobile splash guard to contain rinsing fluid and prevent it from leaving said toilet bowl during a water jet based cleaning process.

The toilet device is preferably equipped with a sidewall rinse that can be activated manually or automatically prior to bowel movement. Such practice improves overall cleanliness. For drying, it can be advisable to use an air knife that covers a sizable area, optionally with an air extract close by to safely remove extra droplets.

Air extracts applied along the rim of the toilet seat can provide additional safety against dislodging of droplets from drying. Alternatively, or in addition, drying can also be assisted by air, optionally heated, that is applied all along the rim of the toilet seat, in alternating geometry to the air extracts for balanced, even and symmetric drying.

In those cases where multiple cameras are in use in the device, cameras can be set up to inspect each other for cleanliness, focus and other.

An example usage cycle can be carried out as follows:

1. User sits down. Presence is detected

2. Touch or voice control log in to start

3. Sidewall pre-rinse (optional)

4. Camera inspects proper seating and warns if not

5. Bowel movement happens

6. Push-button, touch-screen or voice control activation of additional functions
a) Camera move-in, take image of stool, move out
b) Cleaning, rinsing, drying of user's posterior, anal and front genital region
c) Camera inspection of cleaning, log, user with optional comments about any discomforts or other
d) Camera image storage for tracking
e) Clear or initiate redo; redo optionally using joy stick or touch screen or voice control
f) Camera retract and clean using auto-rinse
g) Optional flushing
h) Optional voice, touch-screen or push-button activation and execution of oil/lotion/powder supply.
i) Get up from seat
j) Detect missing presence. Final flushing by detector, voice or push-button activation

7. Done.

Alternatively, during the cleaning process, the camera stays engaged and within the bowl and the user observes the cleaning process and has the option to actively control position, strength and direction of the cleaning spray in real time, using any of the control means such as joy stick, voice actuation, touch screen or other remote control, for best, quickest and most effective cleaning results.

Said described activities provide a multitude of benefits. Not only does it enable the user to have direct feedback and good control over their cleanliness. It also provides capability for early detection of any health issues related either to bowel movement or to the posterior of the person, such as early detection and avoidance of decubitus, of fistulas or hemorrhoids, or even of scrotum infections or necrotic skin tissue in any posterior position of the body. Also, yeast infections or the onset of menstruation can be detected. In addition, when combined with diet diaries, sources for food allergies, diarrhea and constipation can all be detected and correlated earlier and more reliably.

Users benefit from information captured in anonymized data bases, such that abnormalities can be detected and classified. In addition, by processing and correlating images from one particular user's own images over time, changes in skin can be detected and tracked, and problems can be captured early. Sharing such images and data including their history has high value for medical and care providers and may turn out to cut health care costs significantly. This holds not only for mobility or sensory impaired people but also for non-impaired people. Several features presented here require integration and installation of a completely new toilet device. However, it is also envisioned that all or most features can be implemented as part of an add-on kit to an existing toilet device.

What is claimed is:

1. A toilet device, comprising:
a toilet bowl with flushing capability, a toilet seat which houses certain functions,
wherein said toilet seat houses a camera in a moveable arrangement, comprising an extendable and retractable telescopic arm for moving said camera; said camera arrangement thus enabling on-demand viewing of a user's posterior, anal or front genital region or a user's excrement and urine; said camera connected by means of a control system to a viewing monitor, said viewing monitor accessible to the user or to a caregiver supporting said user;

2. the toilet device according to claim 1, additionally containing a bidet function, housed in said toilet seat, including a controllable extendable and retractable telescopic arm with a controllable water-based cleaning jet or shower spray allowing for a water-based cleaning process for a user's posterior, anal or genital region; and wherein said camera allows for viewing said cleaning process or viewing the result of said cleaning process;

3. the toilet device according to claim 1, wherein the connection between the camera and the viewing monitor is wireless;

4. the toilet device according to claim 1, wherein the viewing monitor function is integrated in a device such as a smart phone or tablet;

5. the toilet device according to claim 1, wherein said camera and viewing monitor and control system allows for storing or transferring images or videos taken by the user or their caregiver of a user's posterior, anal or front genital region;

6. the toilet device according to claim 1, wherein said control system allows the user to control camera positions from said viewing monitor;

7. the toilet device according to claim 1, wherein said moveable camera arrangement comprises a cleaning setup with a cleaning line and nozzle as part of the sheath and wherein said moveable camera can receive an automatic or programmable cleaning or drying before or after use, on its way into or out of its protected resting position in a sheath;

8. the toilet device according to claim 1, further comprising a setup for applying an oil, lotion or powder in a controlled fashion, comprising dispense a canister, pressure source, dispense line and a dispense nozzle located on an extendable and retractable arm for positioning of said dispense nozzle, and wherein said camera allows for position, process and quality control of said application of oil, lotion or powder.

9. the toilet device according to claim 2, with a toilet seat, wherein in addition to the water -based cleaning function a drying function, driven by an air pump or fan and comprising a plurality of drying outlets arranged along at least part of the rim of said toilet seat, is implemented.

10. the toilet device according to claim 2, wherein said camera, said cleaning jet or shower spray and said viewing monitor enable the user to actively control said cleaning process;

11. the toilet device according to claim 2, wherein said control system allows the user to control a bidet function from said viewing monitor;

12. the toilet device according to claim 2, wherein said control system allows the user to control a bidet function or a camera function using a joystick located in reachable proximity to a toilet user or by mean of voice actuation;

13. the toilet device according to claim 2, wherein said control system with viewing monitor can be arranged to allow for a caregiver or other second person to carry out and control said cleaning functions for a user;

14. the toilet device according to claim 2, wherein said bidet function comprises a second degree of freedom of motion, said degree being a rotation around the telescopic axis;

15. the toilet device according to claim 2, wherein bidet function and camera function are on separate and independently retractable and extendable arms;

16. the toilet device according to claim 5, wherein said images of a user's posterior, anal or genital region or excrements can be analyzed using image processing;

17. the toilet device according to claim 16, wherein said image processing is comprised of comparing images to stored data base images and wherein skin abnormalities are identified and classified and feedback to the user is given;

18. the toilet device according to claim 7, wherein said cleaning or drying function is integrated close to the front edge of the sheath;

19. A toilet device, comprising:
A toilet bowl with flushing capability, a camera and illumination for viewing a user's posterior, anal or genital function, wherein said camera is installed within said toilet bowl and wherein said installation is located above a toilet default liquid level and wherein said camera is protected from liquid and from soiling by a sealed window; said camera being accessible for maintenance or exchange via a port located along the lower outside edge of said toilet bowl;

20. A method, wherein as part of using a toilet a toilet user inspects and controls the post-excretion cleaning of their posterior, anal or frontal genital region, or views, inspects, takes and stores an image or video of their posterior, anal or front genital region or of their excrement and urine, wherein said cleaning is carried out using toilet paper or a bidet function with a cleaning water-based jet or shower spray; or wherein said user inspects and controls drying of their posterior, anal or genital region, or inspects and controls the targeted application of oils, lotions or powders to the user's posterior, anal or front genital region by themselves or wherein a caregiver assists or controls said cleaning or drying of a user's posterior, anal or front genital regions or the application of an oil, lotion or powder to a user's posterior, anal or front genital region; and wherein said control of precise positioning and extent of cleaning, drying or application of oils, lotions or powder or said cleaning or drying is achieved by means of an extendable and retractable camera, mounted on a telescopic arm and, when retracted, housed within a sheath and wherein said camera can be engaged by means of a control system that connects said camera with a viewing monitor which is accessible to said user or their caregiver, and wherein the control functions can be executed via the use of remote control or on-screen touch screen commands, via a joy stick or via voice actuation.
